(19) United States
(12) Patent Application Publication
(10) Pub. No.: US 2009/0059455 A1
(43) Pub. Date: Mar. 5, 2009

(54) METHOD AND APPARATUS FOR POWER INTERRUPTION PROTECTION

(75) Inventors: Russell Melvin Rosenquist, Plano, TX (US); Thomas Brian Olson, Allen, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/201,938

(22) Filed: Aug. 29, 2008

Related U.S. Application Data
(60) Provisional application No. 60/969,571, filed on Aug. 31, 2007.

(51) Int. Cl. H02H 3/00; H02H 3/20; H02H 3/24

(52) U.S. Cl. 361/90

(57) ABSTRACT

A power interruption protection module, system and method. The power interruption protection module, comprising a charging module for storing a boosted display voltage, a detecting module for identifying at least one of a drop or an increase of a functioning system voltage, wherein at least one of the drop or the increase is beyond a threshold, and a regulating module for receiving a signal from the detecting module, wherein the signal determines at least one of the drop or the increase beyond the threshold, and wherein the regulating module allows or stops the flow of the stored boosted display voltage of the charging module according to the signal of the detecting module.

### CROSS-REFERENCE TO RELATED APPLICATIONS

This application claims benefit of U.S. provisional patent application Ser. No. 60/969,571, filed Aug. 31, 2007, which is herein incorporated by reference.

### BACKGROUND

1. Field of the Invention

Embodiments of the present invention generally relate to power interruption and more specifically to power interruption protection methods and apparatuses for power interruption protection in handheld devices.

2. Description of the Related Art

Some devices lose power momentarily. A momentary power loss can cause memory loss. The momentary power loss can be due to a number of factors. For example, momentary power loss can be caused by dropping a device and/or when a power adapter is plugged into the device there is a power fluctuation(s), that result in no (or insufficient) power to the device. As a result of the momentary power loss, valuable information can be lost.

Prior solutions utilize either a backup battery and/or multiple power sources to prevent momentary power loss. However, these solutions can add to the cost and size of the device.

There is a need to prevent momentary power loss with minimal increase to the overall cost and size of the device.

### SUMMARY

Embodiments disclosed herein generally relate to power interruption protection module, system and method. The power interruption protection module, comprising a charging module for storing a boosted display voltage, a detecting module for identifying at least one of a drop or an increase of a functioning system voltage, wherein at least one of the drop or the increase is beyond a threshold, and a regulating module for receiving a signal from the detecting module, wherein the signal determines at least one of the drop or the increase beyond the threshold, and wherein the regulating module allows or stops the flow of the stored boosted display voltage of the charging module according to the signal of the detecting module.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1a depicts an embodiment of a high level block diagram of a power interruption protection system;

FIG. 1b depicts an embodiment of a block diagram of a power interruption protection module;

FIG. 1c depicts an embodiment of a detailed block diagram of a power interruption protection system;

FIG. 2 depicts a first schematic embodiment of a schematic of a power interruption protection module;

FIG. 3 depicts a second schematic embodiment of a schematic of a power interruption protection module;

FIG. 4 depicts a third schematic embodiment of a power interruption protection module; and

FIG. 5 depicts an embodiment of a flow diagram of a method for power interrupt protection.

### DETAILED DESCRIPTION

The present invention generally relates to power interruption protection method and apparatus for power interruption protection. The method and apparatus may be utilized in a handheld device. A handheld device may be a camera, a camcorder, a calculator, a personal digital assistance (PDA), a phone, and the like. The power interruption protection utilizes boosted display voltage rail to charge at least one capacitor to a higher voltage than the system voltage to detect when a system voltage falls below a threshold. Thus, the purpose of the power interruption protection system is to detect a fall in the system voltage and to transfer a suitable charge to the system voltage when the system voltage falls below such threshold.

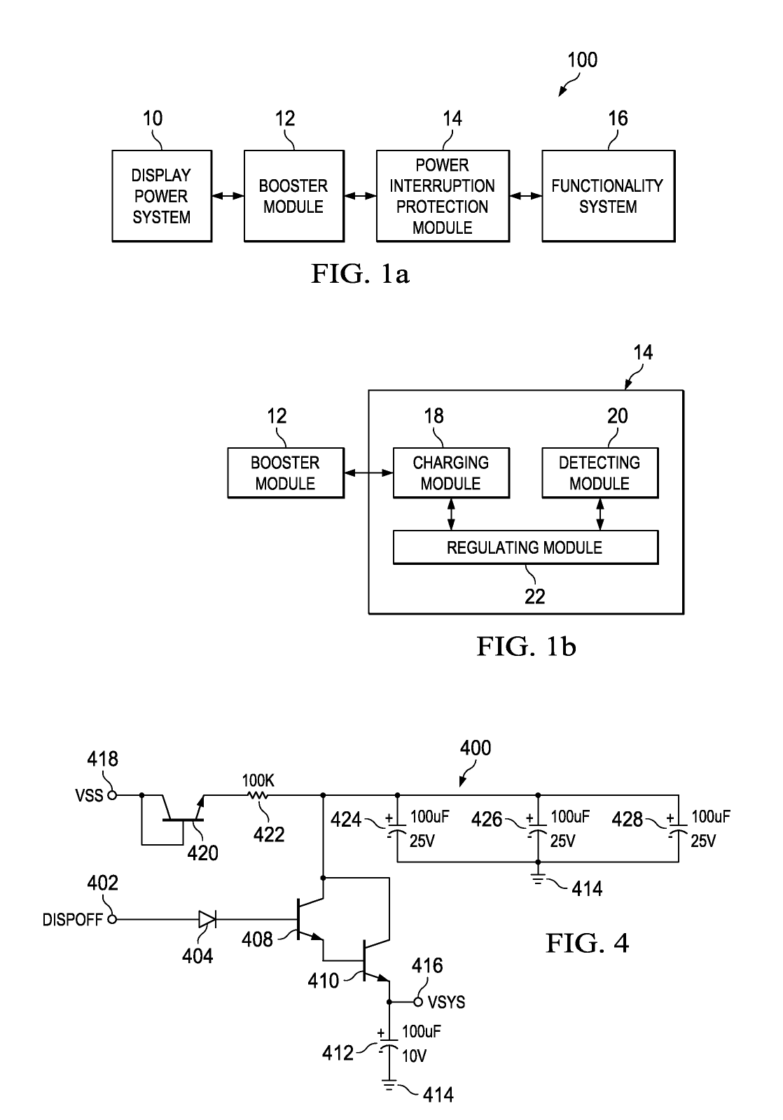

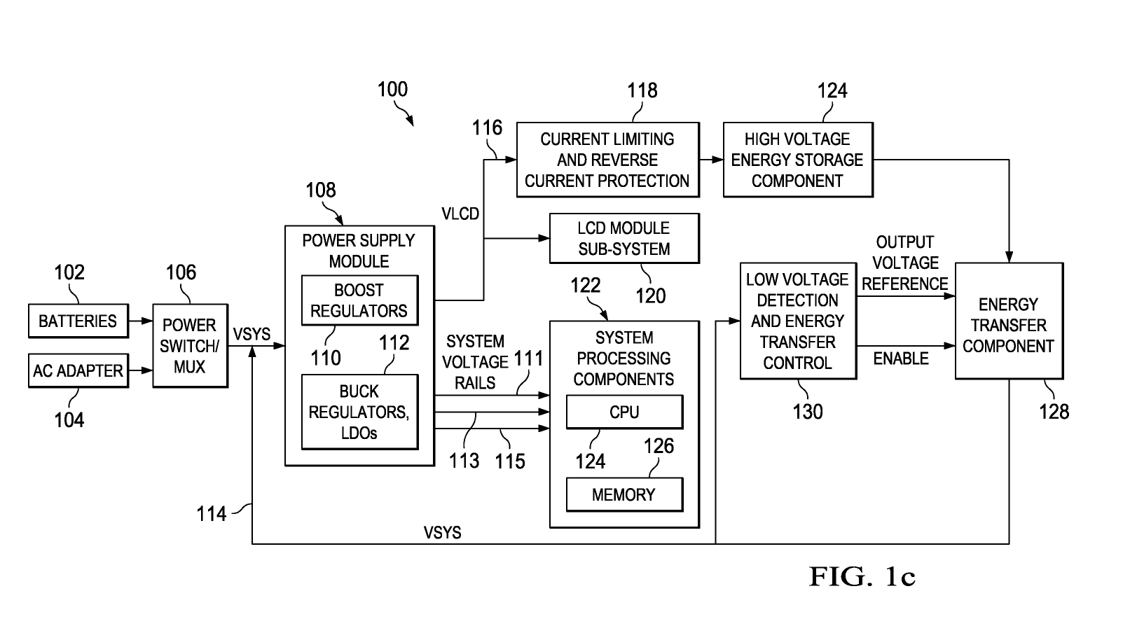

FIG. 1a depicts an embodiment of a high level block diagram of a power interruption protection system 100. The power interruption protection system 100 includes a display power system 10, a booster module 12, a power interruption protection module 14 and a functionality system 16. The display power system 10 is utilized to power a display utilized for displaying various graphics or functionality performed by a system. For example, a display on a calculator is utilized to display user's inputs, functions and calculation outputs. Usually, the display power system 10 is separate from the power system supporting the whole calculator. The voltage output of the display power system 10 is boosted by the booster module 12 to generate a boosted display voltage VLCD (shown in FIGS. 1c, 2, 3 and 4). Therefore, the voltage output of the display power system 10 is boosted by the booster module 12 and utilized to subsidize the voltage of the functionality system 16, if the voltage of the functionality system 16 drops below a threshold.

The power interruption protection module 14 provides power protection to the functionality system 16. The power interruption protection module 14 stores voltage from the display power system 12. When the power interruption protection module 14 recognizes that the functionality system 16 voltage has dropped below a threshold, the power interruption protection module 14 utilizes the boosted display voltage stored from the display power system 12 in the power interruption protection module 14 to provide more voltage to the functionality system 16. Power interruption protection module 14 may step-down the voltage stored in order to provide the functionality system 16 the appropriate voltage.

The functionality system 16 is any system that utilizes a voltage to successfully power ON and to perform the required functionality. For example, the functionality system 16 may be incorporated to perform the functions of a camera, a camcorder, a calculator, a personal digital assistance (PDA), a phone, and the like. If the functionality system 16 loses power, the power interruption protection system 100 prevents the rebooting of the device in the middle of an operation.

FIG. 1b depicts an embodiment of a detailed block diagram of a power interruption protection module 14. The power interruption protection module 14 is coupled to a booster module 18. The booster module 18 may be internal or external to the power interruption protection module 14 or may be incorporated into the display power system 10, shown in FIG. 1a. The power interruption protection module 14 includes a charging module 18, detecting module 20 and a regulating module 22.

The booster module 12 receives voltage from the display power system 10, both shown in FIG. 1a, and produces a boosted display voltage utilized by the power interruption protection module 14, shown as VLCD in FIGS. 1c, 2 and 3. The charging module 18 receives and stores the boosted display voltage (VLCD) from the booster module 12. When the voltage of the functionality system 16 drops or exceeds a threshold, the detecting module detects such a drop or increase. Accordingly, the detecting module 20 signals such drop or increase to the regulating module 22. Hence, the regulating module 22 allows or blocks the voltage from the charging module 18 to the functionality system 16. For example, if the voltage of the functionality system 16 drops to or beyond a threshold, the detecting module 20 signals to the regulating module 22 that a voltage drop has occurred. As a result, the regulating module 22 utilizes the boosted display voltage utilized in the charging module 18 to provide more voltage to the functionality system 16. Similarly, when the voltage exceeds a threshold, the detecting module 20 signals to the regulating module 22 that such increase has occurred. Thus, the regulating module 22 stops the flow of the boosting voltage from the charging module 18 to the functionality system 16.

FIG. 1c depicts an embodiment of a detailed block diagram of a power interruption protection system 100. The power interruption protection system 100 may be incorporated into a portable battery operated device, such as, a camera, a camcorder, a calculator, a remote control, and the like. The power interruption protection system 100 may be adapted to utilize batteries 102, such as, multiple AAA batteries, as a power source and, in various embodiments, is also adapted to receive power from an alternate power source via AC adapter 104.

A power switch/multiplexer 106 receive power from the batteries 102 and/or AC via the AC adapter 104. The power switch 106 determines which power source to accept power from and provides main power to a main power rail (V_{SYS}) in the power interruption protection system 100. V_{SYS} is transmitted towards the power supply module 108 and acts as the main system voltage. The power supply module 108 includes boost regulators 110 and buck regulators/low drop out (LDO) regulators 112 for adjusting the main system voltage V_{SYS}.

Boost regulators 110 receive V_{SYS} and provide high voltage (relative to V_{SYS}), through a boosted display voltage rail, to system components. For example, one boosted display voltage rail V_{LCD} 116, for example, 18 v, is depicted in FIG. 1c, which provides power to a display, such as, a liquid crystal display (LCD) module sub-system 120. Voltage rail 116 also supplies power to a current limiting and reverse current protection module 118.

Buck regulators/LDO's 112 receive V_{SYS} and provide system voltage rails via rails 111, 113 and 115 to the system processing components 122. The system voltage rails are lower voltage than V_{SYS} (e.g., rail 111 provides voltage at about 3.3 v, rail 113 provides voltage at about 1.8 v, and rail 115 provides voltage at about 1.2 v). FIG. 1c depicts the buck regulators/LDO's 112 as providing voltage to three rails; however, any number of rails may be utilized.

The system processing components 122 include a central processing unit (CPU) 122 for controlling circuitry and memory 126 for storing data and control programs and the like. The CPU 122 may comprise one or more conventionally available microprocessors. The microprocessor may be an application specific integrated circuit (ASIC). The memory 126 is any computer readable memory and may comprise random access memory, read only memory, removable disk memory, flash memory, and various combinations of these types of memory. The memory 126 is sometimes referred to main memory and may, in part, be used as cache memory or buffer memory.

Power from the current limiting and reverse current protection module 118 allows voltage rail V_{LCD} 116 to charge a high energy storage component 124, while limiting current by limiting the load on voltage rail V_{LCD} 116. During the time that V_{SYS} is below a voltage threshold, the voltage rail V_{LCD} 116 may prevent the high voltage energy storage component 124 from supplying its stored charge to the LCD module sub-system 120. FIG. 1c depicts utilizing the LCD module sub-system; however, the module sub-system may be the sub-system for any display and is not limited to an LCD.

When a device, incorporating power interruption protection system 100, momentarily loses power, the low voltage detection and energy transfer control module 130 detects the voltage loss in the main system voltage (V_{SYS}) and enables an energy transfer component 128 to transfer energy from the high voltage energy storage component 124 to V_{SYS}. In various embodiments, software can monitor the low voltage detect circuit, such as, using the microprocessor 124. The software may monitor the battery level, which may utilize a hardware interface. Hence, if the processor detects that the battery level or V_{SYS} level is too low, then the processor may enable a general purpose input/output (GPIO) signal that enables the high voltage energy storage component 124 to dump its charge into the system voltage, shut down non-critical components to preserve power, and/or maintain user data and system integrity until a controlled shutdown of the system.

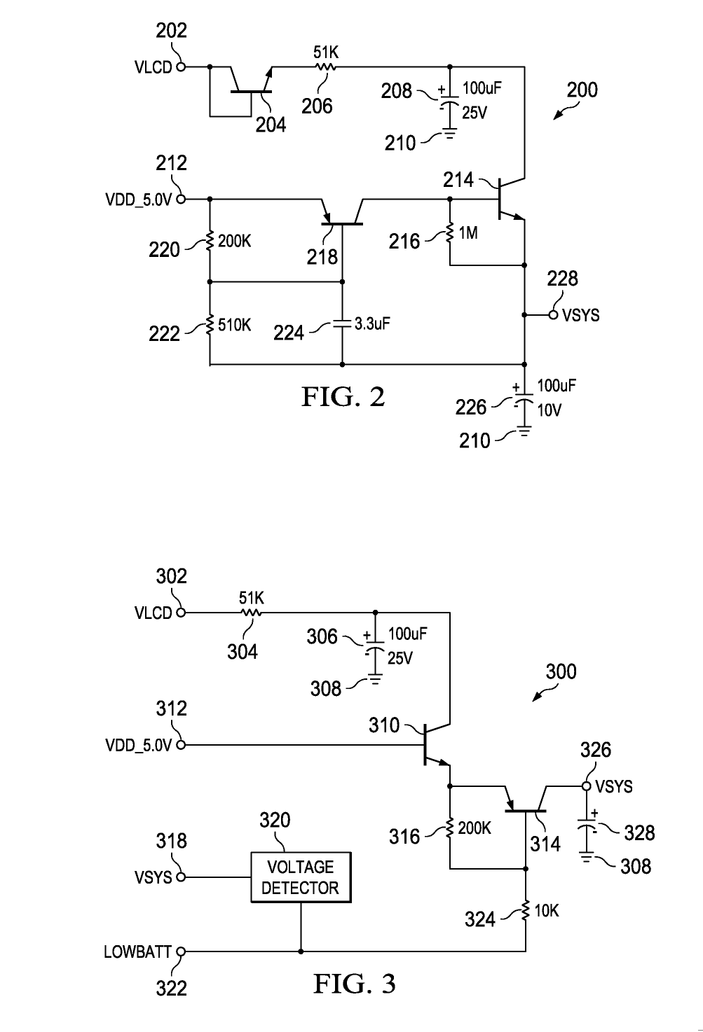

FIG. 2 depicts a first schematic embodiment 200 of a power interruption protection module 14, shown in FIG. 1a-c. Electronic circuit 200 includes transistors 204, 214, and 218; resistors 206, 216, 220, and 222; capacitors 208, 224, and 226; ground 210; system voltage 228 (V_{SYS} 228); power supply 212 (V_{DD} 212); and a boosted display voltage V_{LCD} 202. For illustrative purposes the enabled boost signal is derived from a boosted display voltage supplied to a liquid crystal display (V_{LCD}). However, it is appreciated that other boosted display voltage rails can be used in accordance with aspects disclosed herein.

The first schematic embodiment 200 may be divided into three groups, which are a charging module 18 (FIG. 1), a detector module 20 (FIG. 1), and a regulating module 22 (FIG. 1). The charging module 18 includes the transistor 204, the resistor 206 and the capacitor 208. The detector module 20 includes resistors 220 and 222, transistor 218 and capacitor 224. The regulating module 22 includes transistor 214 and resistor 216. In this the first embodiment schematic, the regulating module includes resistor 216; however, resistor 216 is an optional resistor and in various embodiments resistor 216 is not included in the circuit 200.

In this embodiment, the boosted display voltage V_{LCD} 202 is coupled to on one side the transistor 204 and to the booster module 12, shown in FIGS. 1a and 1b, from the other side. The transistor 204 is couple to boosted display voltage V_{LCD} 202 and the resistor 206. The resistor 206 is couple to capacitor 208 and the transistor 214. The capacitor 208 is grounded to ground 210. The transistor 214 is coupled to resistor 216 and V_{SYS} 228. When V_{SYS} 228 drops, the transistor 214 is ON. One side of the resistor 216 is coupled between the transistor 214 and the transistor 218; the other side of the resistor 216 is connected between the transistor 214 and V_{SYS} 228.

The transistor 218 is coupled to the V_{DD} 212 and transistor 214, wherein the transistor 218 is OFF when V_{SYS} 228 is equal or above a threshold and is ON when V_{SYS} 228 is below or equal to a threshold. One side of the resistor 220 is coupled to the V_{DD} 212 and transistor 218. The second side of the resistor 220 is coupled to the resistor 222 and to the transistor 218 and the capacitor 224. The resistor 222 is coupled from one side to the resistor 220 and the other side to the capacitor 224 and the capacitor 226. One side of the capacitor 224 is coupled to the transistor 218 and the resistor 220 and the other side is coupled to the resistor 222 and the capacitor 226. The capacitor 226 is coupled to V_{SYS} 228, resistor 222 and capacitor 224 and is grounded to ground 210 on the other side.

For illustrative purposes values suitable for some of the elements depicted in FIG. 2 are provided. For example, resistor 206 has a resistance of about 51 kohms; resistor 216 has a resistance of about 1 Mohm; resistor 220 has a resistance of about 200 kohms, resistor 222 has a resistance of about 510 kohms; capacitor 208 has a capacitance of about 100 microfarads; capacitor 224 has a capacitance of about 3.3 microfarads; capacitor 226 has a capacitance of about 100 microfarads; and V_{DD} has a voltage of about 5 volts. The boosted display voltage V_{LCD} 202 is higher than either V_{DD} or V_{SYS} to charge the capacitor 208.

In the circuit 200, V_{LCD} 202 is about 15 volts to about 25 volts (e.g., 18 volts); and the operating range of V_{SYS} 228 is about 6.0 volts to about 3.6 volts. In short, when V_{SYS} falls below 3.6 volts the transistor 214 is enabled and the capacitor 208 dumps its stored voltage to V_{SYS} 228.

When the device, i.e. a calculator, is powered ON, the LCD is ON and the boosted display voltage V_{LCD} 202, from the booster module 12 (shown in FIG. 1) is active. When the device is ON, transistor 204 is ON and V_{SYS} begins charging bulk capacitor 226 up to V_{SYS}; and V_{LCD} 202 begins charging capacitor 208 up to V_{LCD} 202.

Through transistor 204 and resistor 206, V_{LCD} 202 charges the capacitor 208. Resistor 206 is used to minimize the initial current demand (i.e., a current limiter) on V_{LCD} 202 (to prevent V_{LCD} from being directly connected to V_{SYS}) and stores the charge in capacitor 208. In addition, the resistor 206 determines the rate at which capacitor 208 charges.

Under good battery contact conditions, V_{SYS} is kept high enough (i.e., V_{SYS} is close enough to V_{DD}, such as, V_{SYS} about 4.9 v to about 3.6 v, to avoid discharging capacitor 208 since both transistor 218 and transistor 214 are turned OFF. V_{DD} 212 is a 5 v rail derived from V_{SYS}. In the event of a momentary loss in battery contact, such as, V_{SYS} falls below 3.6 v, transistors 218 turns ON and enables transistor 214, such as, transistor 214 is turned ON, to allow capacitor 208 to provide its stored charge to V_{SYS} 228.

Resistors 220 and 222 act as a voltage divider where resistor values for resistors 220 and 222 are selected to keep transistor 218 OFF until the difference between V_{DD} and V_{SYS} is great enough, for example, V_{SYS} is below 3.3 v, to turn transistor 218 ON. The combination of resistors 220 and 222, capacitor 224, and transistor 218 acts as V_{SYS} low voltage detector.

Even if the batteries are removed from the device V_{SYS} does not immediately become 0 v because a regulator (not shown) is still providing voltage to V_{DD} and the difference between V_{DD} and V_{SYS} will be great enough to turn transistor 218 ON. Because of the charge stored in bulk capacitor 226, V_{SYS} will drop before it becomes 0 v. In this embodiment, when V_{SYS} falls below 3.3. v, transistor 218 turns ON and enables transistor 214 (i.e., turns transistor 214 ON) for the transfer of charge stored in capacitor 208 to V_{SYS} though transistor 214.

In circuit 200, when transistor 214 turns ON, the voltage at V_{SYS} 228 increases and causes transistors 214 and 218 to turn OFF. Transistor 214 turns OFF because transistor 214 is a voltage follower. Because transistor 214 is a voltage follower, the voltage at the emitter (V_{E}) of transistor 214 can never be higher than V_{B}−V_{BE}. In one embodiment, once V_{E} gets to 4.3 v, for example, 5 v-0.7 v, transistor 214 turns OFF. This prevents capacitor 208 from overcharging V_{SYS} and exceeding 5 v, minus the drop across transistor 218. As a result, capacitor 208 and bulk capacitor 226 may cycle the voltage between them, thus, extending the time the power interruption protection system utilizes the voltage stored in the capacitor 208 and bulk capacitor 226.

However, if the difference between V_{DD} and V_{SYS} is large enough, such as, V_{SYS} below 3.3 v, transistor 218 turns ON again to enable transistor 214. When transistor 214 is enabled, capacitor 206 provides more of its stored charge to V_{SYS} 228 through transistor 214. The process of transistor 218 turning ON and enabling transistor 214 is repeated until connection to the battery is reestablished. When the device is OFF, the current demand for maintaining the calculator is relatively small and bulk capacitor 226 may be sufficient to maintain V_{SYS}.

FIG. 3 depicts a second schematic embodiment 300 of a schematic of a power interruption protection module 14. The second schematic embodiment 300 includes transistors 310 and 314; resistors 304, 316, and 324; capacitor 306 and bulk capacitor 328; ground 308; system voltage 326 (V_{SYS} 326); system voltage 318 (V_{SYS} 318); power supply 312 (V_{DD} 212); a voltage detector 320; a low battery indicator 322; and a boosted display voltage V_{LCD} 302. For illustrative purposes, the enabled boost signal is derived from the voltage supplied to a liquid crystal display (V_{LCD} 302).

The second schematic embodiment 300 includes a charging module 18 (shown in FIG. 1), a detecting module 20 (shown in FIG. 1) and a regulating module 22 (shown in FIG. 1). In this embodiment, the charging module 18 includes resistor 304 and capacitor 306. The detecting module 20 includes voltage detector 320, which operates as a switch. The regulating module 22 includes resistors 316 and 324, transistors 310 and 314 and buck capacitor 328.

The boosted display voltage V_{LCD} 302 is coupled to the resistor 304 from one side and the booster module 12 (FIGS. 1a and b) from the other side. The other side of the resistor 304 is coupled to the capacitor 306 and one side of the transistor 310. The capacitor 306 is coupled to the resistor 304 from one side and the ground 308 from the other side. The transistor 310 is coupled to the V_{DD} 312 from the second side; while the third side of the transistor 310 is coupled to the resistor 316 and the transistor 314. The second side of the resistor 316 is coupled to the second end of the transistor 314 and the resistor 324. The third side of the transistor 314 is coupled to the V_{SYS} 326 and the capacitor 328.

The capacitor 328 is grounded to ground 308 on the second side. The second side of the resistor 324 is coupled to the voltage detector 320 and the low battery indicator 322. The voltage detector 320 is also coupled to the V_{SYS} 318.

For illustrative purposes, values suitable for some of the elements are depicted in FIG. 3. For example, resistor 304 has a resistance of about 51 kohms; resistor 316 has a resistance of about 200 kohms; resistor 324 has a resistance of about 10 kohms; capacitor 306 has a capacitance of about 100 microfarads; and V_{DD} has a voltage of about 5 volts. The enabled boost signal 302 (depicted as V_{LCD}) is higher than either V_{DD} or V_{SYS} to charge the capacitor 306. Illustratively, the enabled boost signal (i.e., V_{LCD}) is about 15 volts to about 20 volts.

When the device is ON, capacitor 306 stores charge until the capacitor 306 is fully charged or until the system voltage falls below a threshold. When there is an indication that there is a low battery signal, transistors 310 and 314 are turned ON permitting V_{SYS} 326 to be supplied voltage from the stored charge in capacitor 306.

Transistor 310 is a voltage follower and operates similarly to the voltage follower 214 described above and depicted in FIG. 2. There is a voltage detector 320 connected to V_{SYS} 318. When the voltage detector 320 detects that V_{SYS} 318 is below a threshold, the voltage detector 320 transmits a signal indicative of the low voltage detection at V_{SYS} 318. The low voltage detection signal is transmitted through resistor 324 to the base of transistor 314 causing transistor 314 to turn ON.

As transistor 314 turns ON, voltage at a node connecting transistor 310 to resistor 316 is sufficiently lower than V_{DD} to turn ON transistor 310. Resistor 316 works in conjunction with resistor 324 (a voltage divider configuration) to ensure that transistors 310 and 314 are OFF when the LOWBAT signal is low and ON when the LOWBAT signal is high. Transistor 310 is a voltage follower that, when ON, allows capacitor 306 to discharge through transistors 310 and 314 to V_{SYS} 326. When the voltage detector 320 determines that V_{SYS} 318 is equal or above a threshold, voltage detector 320 transmits a signal indicative of the high voltage at V_{SYS} 318 to turn OFF transistor 314.

In various embodiments, a pin on a microprocessor can be connected to law bat signal 322. When the voltage detector 320 detects low battery signal, the microprocessor may initiate a controlled shutdown, turning OFF certain processor functions (e.g., functions which use relatively higher power) or turning on other component to turn on the transistor 314.

FIG. 4 depicts a third schematic embodiment 400 of a power interruption protection module 14. FIG. 4 depicts multiple charge capacitors based on the amount of charge to be transferred to V_{SYS} and an alternative arrangement for switching and detecting when V_{SYS} falls below a threshold. Rather than using a 5 volt V_{DD} voltage rail (depicted in FIGS. 2 and 3 and described above), a different voltage rail can be used (e.g., a 3.3 volt voltage rail).

Electronic circuit 400 includes transistors 408, 410, and 420; resistor 422; capacitors 412, 424, 426, and 428; ground 414; system voltage 416 (V_{SYS} 416); DISPOFF 402; a diode 404 (e.g. Schottky); and a boost voltage V_{SS} 418. For illustrative purposes the boosted display voltage is derived from the voltage supplied to a display (V_{SS}).

In this embodiment, two side of the transistor 420 are coupled to V_{SS} 418. The third side of the transistor 420 is coupled to the resistor 422. The other side of the resistor 422 is coupled to the transistor 408 and 410 and capacitors 424, 426 and 428. The other sides of the capacitors 424, 426, and 428 are coupled to each other. The second side of the transistor 408 is coupled to the diode 404. The second side of the diode 404 is coupled to the DISPOFF 402. The third side of the transistor 410 is coupled to the third side of the transistor 408. The third side of the transistor 410 is coupled to the V_{SYS} 416 and the first side of the capacitor 412. The second side of the capacitor 412 is grounded to ground 414.

For illustrative purposes, values suitable for some of the elements depicted in FIG. 4 are provided. For example, resistor 422 has a resistance of about 100 kohms; and capacitors 412, 424, 426, and 428 each have a capacitance of about 100 microfarads. The enabled boost signal V_{SS} 418 is higher than either DISPOFF 402 or V_{SYS} 416 to charge the capacitors 424, 426, and 428. V_{SS} 418 is about 15 volts to about 20 volts; the operating range of V_{SYS} 416 is about 2.9 volts to about 1.6 volts; and DISPOFF 402 is about 3.3 volts.

Resistor 422 operates similarly to resistor 206, described in FIG. 2 and described above, and resistor 304, described in FIG. 3. As such, an explanation of the operation/purpose of resistor 422 is not repeated in great detail.

When a device, having the circuitry of schematic 400, is ON the device display is also ON. A boosted display voltage rail (e.g., about 18 volts) supplies voltage to V_{SS} 418 and is available when the device is ON. DISPOFF is also available when the device is ON and is maintained at about 3.3 volts. While the device is ON, current used for the device is higher than when the device is in the OFF state. Thus, when the device is ON, it will use the stored charge on the system voltage V_{SYS} 418 faster than when the device is OFF. When the device is OFF, charge stored in the bulk capacitor 328 is usually sufficient to provide its stored charge to V_{SYS} to power the system components.

However, when the device is ON and a momentary loss of contact with the battery occurs, the charge stored in bulk capacitor 412 is usually insufficient to maintain V_{SYS} until reconnection with the battery occurs. To maintain sufficient charge on V_{SYS} during a loss of contact with the battery, when the device is ON, requires increasing the amount of bulk capacitance connected directly to V_{SYS}, which is done by either increasing the capacitance of bulk capacitor 412 and/or adding capacitors to bulk capacitor 412. However, as indicated above, increasing bulk capacitor 412 adds to the overall cost and size of the system.

In contrast, circuitry 400 utilizes capacitors 424, 426, and 428 which can be low cost bulk capacitors that charge up to about the maximum voltage (e.g., about 18 volts) provided by the boosted display voltage rail V_{SS} 418, when the display is ON. As explained above, resistor 422 is a current limiting resistor and determines the rate at which capacitors 424, 426, and 428 are charged.

The DISPOFF 402 signal is high when the display is ON and is used to enable the circuit 400. DISPOFF 402 is set at the 3.3V rail. In the event of a power fluctuation of V_{SYS} below the threshold (i.e., when V_{SYS} falls below 2 volts), the voltage difference between the base and emitter of transistor 408 cause transistors 408 and 410 turn ON allowing V_{SYS} to be maintained by the capacitors 424, 426, and 428. As V_{SYS} drops, there may be enough voltage at DISPOFF 402 to keep DISPOFF high enough, such that there is a potential difference between DISPOFF 402 and V_{SYS} 416 in the positive direction.

Diode 406, transistor 408 and transistor 410 act as a voltage follower system. The addition of diode 406 and transistor 408 requires a higher voltage difference to turn on transistor 410 than a voltage follower without diode 406 and transistor 408 (e.g., the voltage follower depicted in FIG. 2). For example, in transistor 410, the difference between the base and emitter may be 0.7 volts before transistor 410 turns ON. However, with the addition of the diode 406 and the transistor 408, the voltage drop across each of these components (e.g., 0.7 volts across each component) may be included before the transistor 410 turns ON. Therefore, there is a greater voltage difference between DISPOFF 402 and V_{SYS} before transistor 410 turns ON. Though FIG. 4 shows the diode 406, the third embodiment 400 may or may not include the diode 406.

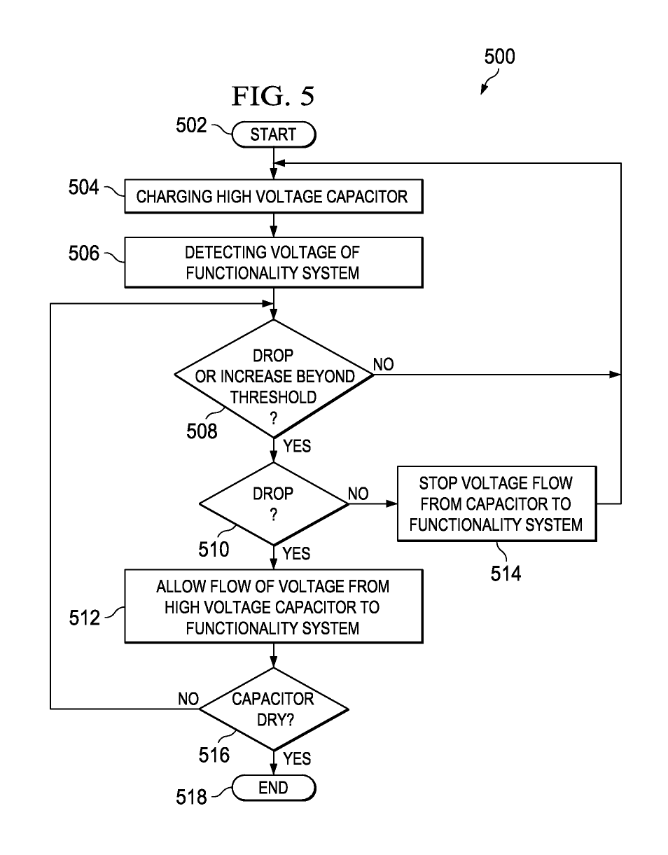

FIG. 5 depicts an embodiment of a flow diagram of a method 500 for power interrupt protection. The method starts at step 502 and proceeds to step 504. At step 504, the method 500 charges a high voltage capacitor from boosted display voltage. At step 506, the method 500 detects voltage drops or increases of a functionality system. If the drop or increase is beyond a threshold, then the method 500 proceeds from step 508 to step 510. Otherwise the method 500 returns from step 508 to step 504. At step 510, the method checks if there was a voltage drop in the functionality system beyond a threshold. If the change is an increase, not a drop, then the method 500 proceeds from step 510 to step 514. At step 514, the method 500 stops the flow of the voltage from the high voltage capacitor to the functionality system. From step 514, the method 500 returns to step 504.

If the change is a drop, the method proceeds to step 512, wherein the voltage charged in the high voltage capacitor is allowed to flow to the functionality system. From step 512, the method 500 proceeds to step 516, wherein the method 500 checks if the high voltage capacitor is drained. If the high voltage capacitor is not drained of voltage, the method 500 returns to step 508. If the high voltage capacitor is drained the method 500 ends at step 518.

While the foregoing is directed to embodiments of the present invention, other and further embodiments of the invention may be devised without departing from the basic scope thereof, and the scope thereof is determined by the claims that follow.

We claim:

1. A power interruption protection module, comprising:
a charging module for storing a boosted display voltage;
a detecting module for identifying at least one of a drop or an increase of a functioning system voltage, wherein at least one of the drop or the increase is beyond a threshold; and
a regulating module for receiving a signal from the detecting module, wherein the signal determines at least one of the drop or the increase beyond the threshold, and wherein the regulating module allows or stops the flow of the stored boosted display voltage of the charging module according to the signal of the detecting module.

2. The power interruption protection module of claim 1, wherein the charging module comprises a high voltage capacitor for reserving the boosted display voltage.

3. The power interruption protection module of claim 1, wherein the detecting module comprises a transistor coupled to a functionality system and adapted to at least one of turn ON or OFF in response to at least one of the drop or the increase of the voltage of the functionality module beyond the threshold turns the transistor ON or OFF.

4. The power interruption protection module of claim 1, wherein the threshold for a drop and the threshold for the increase are different.

5. The power interruption protection module of claim 1, wherein at least one of the detector module or the regulating module comprises a microprocessor.

6. The power interruption protection module of claim 1, wherein the regulating module comprises a bulk capacitor

7. The power interruption protection module of claim 6, wherein the charging module and the bulk capacitor cooperate together causing the voltage stored in the charging module and the bulk capacitor to cycle more than one time through power interruption protection module.

8. The power interruption protection module of claim 7, wherein the cycling of the voltage between the charging module and the bulk capacitor increases the time the functioning system is powered ON when the voltage of the functioning system drops beyond the threshold.

9. The power interruption protection module of claim 1, wherein the regulating module steps-down the boosted display voltage stored in the charging module for providing the appropriate voltage to the functionality system.

10. The power interruption protection module of claim 1, wherein the functionality module performs the functions of a calculator.

11. A computer readable medium comprising executable instruction, when executed, causes the computer to perform a power interruption method, wherein the power interruption protection method comprises:
storing a boosted display voltage in a high voltage capacitor;
identifying at least one of a drop or an increase of a functioning system voltage, wherein at least one of the drop or the increase is beyond a threshold; and
at least one of allowing or stopping the flow of the stored boosted display voltage to the functionality system according to the identified drop or increase.

12. The computer readable medium of claims 11, wherein the power interruption protection method further comprises stepping down the boosted display voltage to provide the appropriate voltage to the functionality system

13. The computer readable medium of claim 11, wherein the boosted display voltage is stored in a high voltage capacitor.

14. The computer readable medium of claim 13, wherein a voltage is stored in a bulk capacitor.

15. The computer readable medium of claim 14, wherein the power interruption protection method further comprises cycling of the voltage between the high voltage capacitor and the bulk capacitor.

16. A power interruption protection system, comprising:
a battery for providing a display with display voltage;
a booster module for boosting the display voltage;
a charging module for storing the boosted display voltage, wherein the charging module comprises a high voltage capacitor;
a detecting module for identifying at least one of a drop or an increase of a functioning system voltage, wherein at least one of the drop or the increase is beyond a threshold; and
a regulating module for receiving a signal from the detecting module, wherein the signal determines at least one of the drop or the increase beyond the threshold, and wherein the regulating module allows or stops the flow of the stored boosted display voltage of the charging module according to the signal of the detecting module, and
wherein the regulating module steps down the stored boosted display voltage to a voltage appropriate for the functioning system.

17. The power interruption protection system of claim 16, wherein the regulating module comprises a bulk capacitor.

18. The power interruption protection system of claim 17, wherein the charging module and the bulk capacitor cooperate together causing the voltage stored in the charging module and the bulk capacitor to cycle more than one time through power interruption protection system.

19. The power interruption protection system of claim 18, wherein the cycling of the voltage between the charging module and the bulk capacitor increases the time the functioning system is powered ON when the voltage of the functioning system drops beyond the threshold.
